(19) United States
(12) Patent Application Publication
(10) Pub. No.: US 2025/0115331 A1
(43) Pub. Date: Apr. 10, 2025

(54) STORAGE FOR A SNOWMOBILE

(71) Applicant: Polaris Industries Inc., Medina, MN (US)

(72) Inventors: Jason P. Delor, Wyoming, MN (US); Michael J. Hanten, Delano, MN (US); Cameron D. Fisher, Plymouth, MN (US); Benjamin D. Dieter, Roseau, MN (US); Michael F. Donoughe, Wyoming, MN (US); Derek R. Thibert, Roseau, MN (US); Cory A. Wimpfheimer, Roseau, MN (US); James E. Rogala, Medina, MN (US)

(73) Assignee: Polaris Industries Inc., Medina, MN (US)

(21) Appl. No.: 18/834,897

(22) PCT Filed: Feb. 7, 2023
(86) PCT No.: PCT/US2023/062105

§ 371 Date: Jul. 31, 2024

Related U.S. Application Data
(60) Provisional application No. 63/311,740, filed on Feb. 18, 2022.

(51) Int. Cl. B62M 27/02

(52) U.S. Cl. CPC B62M 27/02; B62M 2027/028

(57) ABSTRACT

A snowmobile may include an endless track, an electric powertrain operatively coupled to the endless track and a structural frame including a rear portion including a tunnel and a front portion positioned forward of the tunnel. The snowmobile may include a steering assembly and a straddle seat positioned along the longitudinal axis of the snowmobile over the endless track. The straddle seat may extend longitudinally rearward of the steering assembly. The straddle seat has a longitudinal front extent, a longitudinal rear extent, and a longitudinal mid-point. The snowmobile may include a storage support above the endless track and extending under the straddle seat of the snowmobile. The storage support may be accessible along a longitudinal direction of the snowmobile while the straddle seat is supported by a seat support and may extend longitudinally along the tunnel from a location rearward of the straddle seat to at least forward of the longitudinal mid-point of the straddle seat. The snowmobile may include a cantilevered straddle seat. The snowmobile may include a pass through storage positioned above the skis.

### FIELD OF THE DISCLOSURE

The present disclosure relates to snowmobiles and, more particularly, to storage for snowmobiles.

### BACKGROUND

Generally, snowmobiles are available for various applications such as deep snow, high performance, luxury touring, and trail riding, for example. These applications may require that the riders be able to store and/or tow objects for use such as skis, snowboards, tools, food, or various other accessories and items. There remains a need for increased storage within snowmobiles for storing and towing desired objections.

### SUMMARY OF THE DISCLOSURE

In an exemplary embodiment of the present disclosure, a snowmobile is provided. The snowmobile includes a plurality of ground engaging members including an endless track, a left front ski, a right front ski, the endless track being positioned rearward of the left front ski and the right front ski, an electric powertrain operatively coupled to the endless track to power movement of the endless track and a structural frame supported by the plurality of ground engaging members, the structural frame including a rear portion including a tunnel and a front portion positioned forward of the tunnel. The snowmobile further includes a steering assembly supported by the structural frame and operatively coupled to the left front ski and the right front ski to steer the snowmobile and a seat support supported by the plurality of ground engaging members. The snowmobile includes a straddle seat supported by the seat support and positioned along the longitudinal axis of the snowmobile over the endless track, the straddle seat extending longitudinally rearward of the steering post of the steering assembly, the straddle seat has a longitudinal front extent, a longitudinal rear extent, and a longitudinal mid-point. The snowmobile further includes a storage support above the endless track and extending under the straddle seat of the snowmobile, the storage support being accessible along a longitudinal direction of the snowmobile while the straddle seat is supported by the seat support, the storage support extends longitudinally along the tunnel from a location rearward of the longitudinal rear extent of the straddle seat to at least forward of the longitudinal mid-point of the straddle seat.

In an example thereof, the storage support extends longitudinally under an entire length of the straddle seat.

In another example thereof, the storage support extends longitudinally from the location rearward of the longitudinal rear extent of the straddle seat to at least a rotational axis of a drive sprocket engaged with the endless track.

In a further example thereof, the storage support extends longitudinally from the location rearward of the longitudinal rear extent of the straddle seat to at least a front lateral extent of the tunnel

In a further example thereof, the storage support extends longitudinally from the location rearward of the longitudinal rear extent of the straddle seat to at least a spindle axis of the left front ski

In a further example thereof, the storage support extends longitudinally from the location rearward of the longitudinal rear extent of the straddle seat to a front longitudinal extent of the snowmobile.

In another example thereof, the storage support has a bottom support structure and at least a portion of storage support has at least a first lateral sidewall to enclose the storage support on at least one lateral side.

In a further example thereof, the storage support has a bottom support structure and at least a portion of storage support has at least a first lateral sidewall and a second lateral sidewall to enclose the storage support on both lateral sides.

In a further example thereof, the storage support has a bottom support structure and at least a portion of storage support has at least a first lateral sidewall and a second lateral sidewall to enclose the storage support on both lateral sides and a top wall to enclose the storage support from above

In another example thereof, the portion of the storage support has a front stop wall.

In a further example thereof, the storage support includes a first portion which is enclosed on both lateral sides, a front, and a top and a second portion which is accessible along the longitudinal direction of the snowmobile and at least one lateral side of the snowmobile.

In a further example thereof, the second portion of the storage support is exposed to the environment on at least a first side, second side, and a top side

In another example thereof, the snowmobile includes an enclosed storage compartment separate from the storage support.

In another example thereof, the snowmobile includes a plurality of body panels positioned forward of the straddle seat, wherein the enclosed storage compartment is accessible through at least one of the plurality of body panels.

In yet a further example thereof, the plurality of body panels includes a hinged hood which provides access to the enclosed storage compartment.

In a further example thereof, the snowmobile includes a heating system which is positioned to heat the enclosed storage compartment of the snowmobile.

In a further example thereof, the electric powertrain includes an electric motor operatively coupled to the endless track and at least one battery operatively coupled to the electric motor, the heating system removing heat from at least one of the electric motor and the at least one battery to regulate a temperature of the enclosed storage compartment.

In a further example thereof, the storage support includes a plurality of interfaces adapted to couple cargo to the storage support.

In a further example thereof, the plurality of interfaces cooperate with expandable retainers to couple cargo to the storage support.

In yet a further example thereof, at least one battery is positioned between the storage support and the tunnel.

In a further example thereof, a passenger seat is operatively coupled to the tunnel and the storage support extends underneath the passenger seat.

In a further example thereof, a supplemental battery is operatively coupled to the tunnel and extends at least partially beneath the straddle seat.

In a further exemplary embodiment of the present disclosure, a snowmobile extending along a longitudinal axis is provided. The snowmobile comprising: a plurality of ground engaging members including an endless track, a left front ski, and a right front ski, the endless track being positioned rearward of the left front ski and the right front ski; an electric powertrain operatively coupled to the endless track to power movement of the endless track; a structural frame supported by the plurality of ground engaging members, the structural frame including a rear portion including a tunnel and a front portion positioned forward of the tunnel; a steering assembly supported by the structural frame and operatively coupled to the left front ski and the right front ski to steer the snowmobile; a seat support supported by the plurality of ground engaging members; a straddle seat supported by the seat support and positioned along the longitudinal axis of the snowmobile over the endless track, the straddle seat extending longitudinally rearward of the steering post of the steering assembly; a plurality of body panels positioned forward of the endless track, the plurality of body panels including a removable left side lateral body panel and a removable right side lateral body panel; and a storage support positioned forward of the endless track, the storage support having an interior accessible through both the removable left side lateral body panel and the removable right side lateral body panel.

In an example thereof, the storage support is positioned over the left front ski and the right front ski.

In yet a further exemplary embodiment of the present disclosure, a snowmobile extending along a longitudinal axis is provided. The snowmobile comprising: a plurality of ground engaging members including an endless track, a left front ski, and a right front ski, the endless track being positioned rearward of the left front ski and the right front ski; an electric powertrain operatively coupled to the endless track to power movement of the endless track; a structural frame supported by the plurality of ground engaging members, the structural frame including a rear portion including a tunnel and a front portion positioned forward of the tunnel; a steering assembly supported by the structural frame and operatively coupled to the left front ski and the right front ski to steer the snowmobile; a seat support supported by the plurality of ground engaging members; and a cantilevered straddle seat supported by the seat support and positioned along the longitudinal axis of the snowmobile over the endless track, the cantilevered straddle seat extending longitudinally rearward of the steering post of the steering assembly.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of the invention(s) disclosed herein will become more readily appreciated as the same becomes better understood by reference to the following detailed description when taken in conjunction with the accompanying drawings.

FIG. 1 illustrates a left perspective view of an exemplary snowmobile;

FIG. 2 illustrates a left side view of an exemplary frame of the exemplary snowmobile of FIG. 1;

FIG. 3 illustrates a top view of the exemplary frame of FIG. 2;

FIG. 4 illustrates an exemplary electric powertrain assembly of the exemplary snowmobile of FIG. 1;

FIG. 5 illustrates a right side view of an exemplary snowmobile illustrating an exemplary storage support of the snowmobile;

FIG. 6 illustrates a top representative view of components of the exemplary snowmobile of FIG. 5;

FIGS. 7A-7E illustrate various configurations of a storage support for use with the exemplary snowmobile of FIG. 5;

FIG. 8 illustrates a right side view of the exemplary snowmobile of FIG. 5 with varying accessories in the storage support;

FIG. 9 illustrates an enlarged view of a portion of the storage support of the exemplary snowmobile of FIG. 5;

FIG. 10 illustrates a right side view of the exemplary snowmobile of FIG. 5 with additional accessories incorporated into the exemplary storage support;

FIG. 11 illustrates a right side view of the exemplary snowmobile of FIG. 5 with additional accessories incorporated into the exemplary storage support;

FIG. 12 illustrates a right side view of the exemplary snowmobile of FIG. 5 with additional accessories incorporated into the exemplary storage support;

FIG. 13 illustrates a schematic of a heating system for a storage support for use with an exemplary snowmobile;

FIG. 14 illustrates an enlarged view of a portion of an exemplary storage support of the snowmobile of FIG. 5;

FIG. 15A illustrates an enlarged view of a portion of an exemplary snowmobile including an exemplary storage support;

FIG. 15B illustrates an enlarged view of the portion of the exemplary snowmobile of FIG. 15A;

FIG. 15C illustrates an enlarged view of the portion of the exemplary snowmobile of FIG. 15C;

FIG. 16 illustrates a portion of an exemplary snowmobile including an exemplary storage support; and

FIG. 17 illustrates a portion of a seat assembly of an exemplary snowmobile.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. For example, while the following description refers primarily to a snowmobile, it should be understood that the principles of the invention apply equally to other snow vehicles. While the disclosure relates to snowmobiles, it is contemplated that the present disclosure is applicable to any tracked vehicle or vehicle that includes a track and, as such, the invention(s) of the present application are not to be limited to snowmobiles.

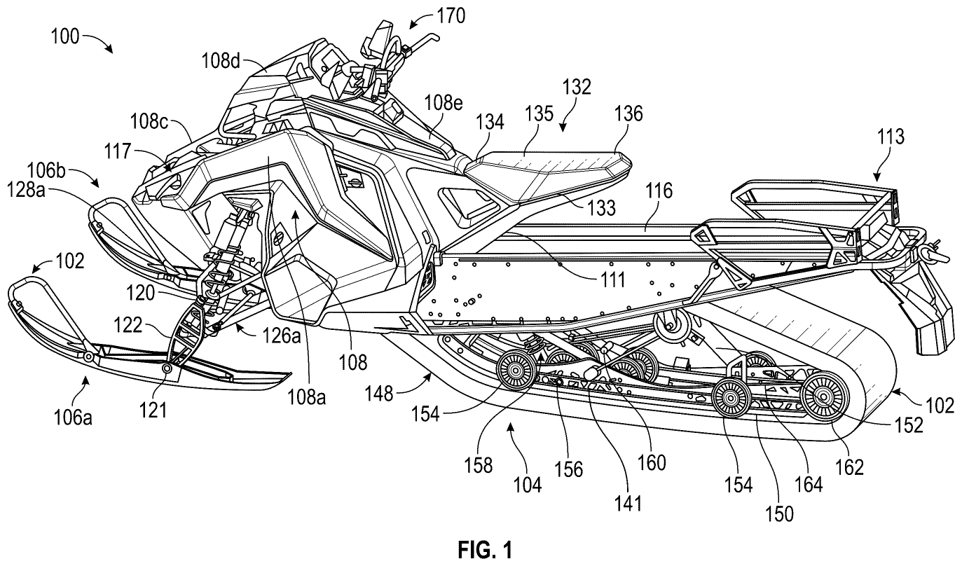

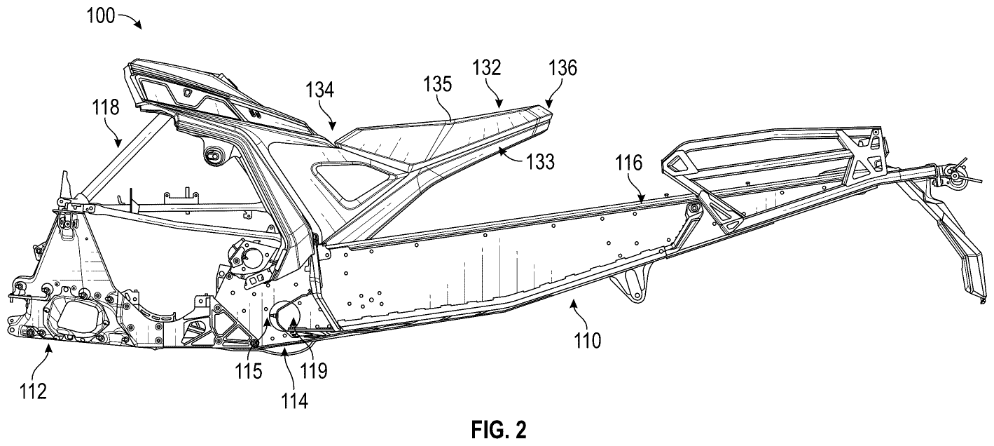

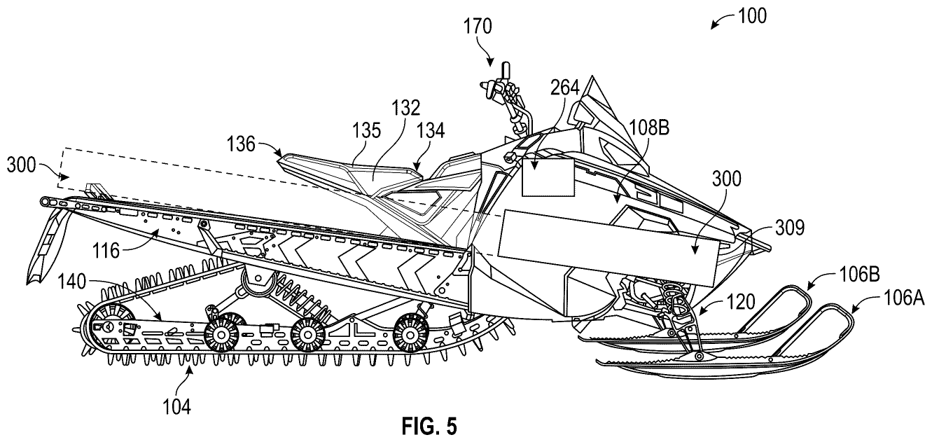

Referring to FIG. 1, an illustrative embodiment of a snowmobile 100 is shown. Snowmobile 100 includes a plurality of body panels 108. Specifically, snowmobile 100 comprises a left side panel 108a, a right side panel 108b (FIG. 5), and a front panel 108c. Front panel 108c may also be referred to as a hood. Snowmobile 100 may additionally include a top body panel 108d positioned forward of various instruments of the snowmobile 100 and a rear body panel 108e positioned rearward of the various instruments. The instruments may include steering assembly structures, an operator interface, and various other applicable instruments. Snowmobile 100 additionally includes a plurality of ground engaging members 102. Illustratively, ground engaging members 102 include an endless track assembly 104 including endless track belt 148, and a pair of front skis 106, specifically a front left ski 106A and a front right ski 106B (see FIG. 2). Endless track assembly 104 supports a rear portion of snowmobile 100 while skis 106 support a front portion of snowmobile 100. Further, endless track assembly 104 is operatively coupled to an electric powertrain assembly 200.

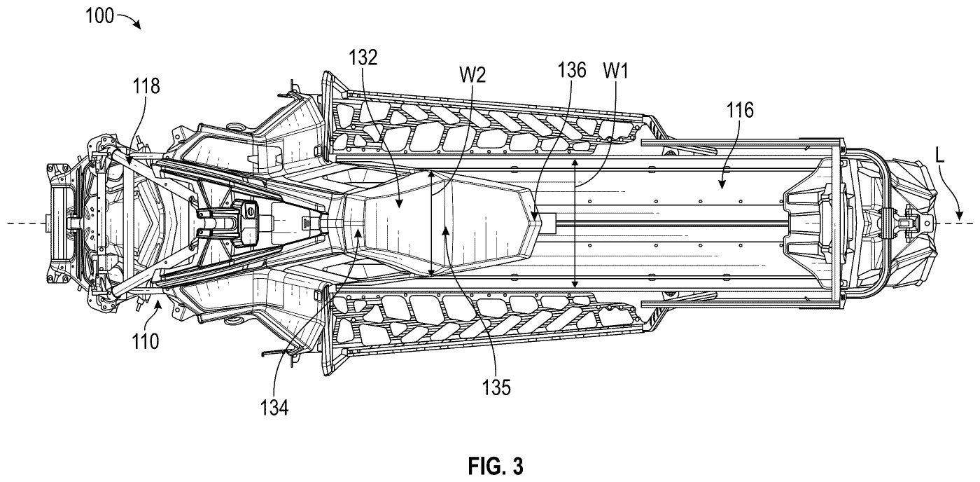

Referring to FIGS. 2 and 3, snowmobile 100 includes a structural frame 110 extending along a longitudinal centerline L. Structural frame 110 includes a front frame portion 112 which is generally supported by skis 106. Structural frame 110 further includes a tunnel 116 which is generally supported by endless track assembly 104 and a middle frame portion 114 connecting front frame portion 112 and tunnel 116. Tunnel 116 extends from a real longitudinal end 111 and a front longitudinal end 113. Additionally, structural frame 110 may include an overstructure 118 which supports a steering assembly 170 of snowmobile 100. In the illustrated embodiment, front frame portion 112, middle frame portion 114, tunnel 116 and overstructure 118 are coupled together with fasteners, weldments, adhesives or other suitable couplers. In embodiments, one or more of front frame portion 112, middle frame portion 114, tunnel 116, and overstructure 118 are integrally formed with another of front frame portion 112, middle frame portion 114, tunnel 116, and overstructure 118. Exemplary frames are disclosed in U.S. Pat. No. 8,490,731 titled “SNOWMOBILE”, the entire disclosure of which is expressly incorporated by reference herein.

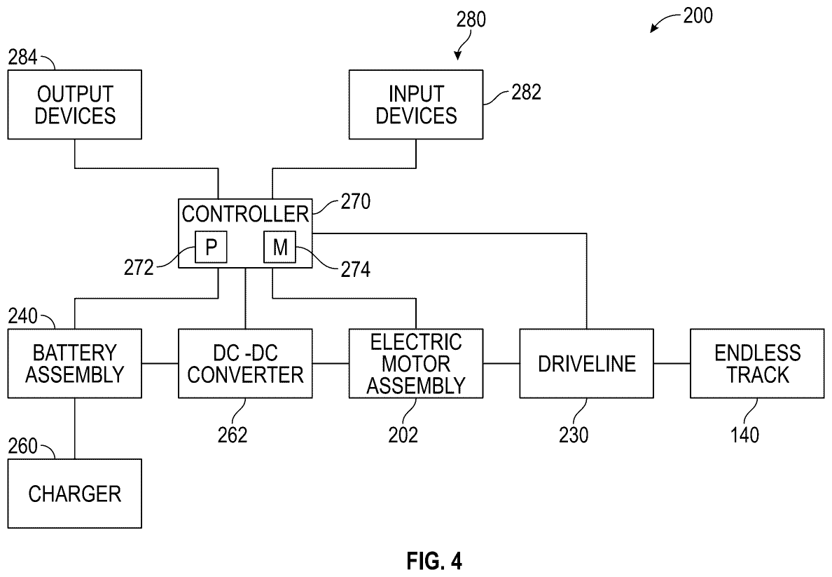

Each of front frame portion 112, middle frame portion 114, tunnel 116, and overstructure 118 is a part of structural frame 110. Structural frame 110 provides structural rigidity for snowmobile 100. As explained herein each of front frame portion 112, middle frame portion 114, tunnel 116, and overstructure 118 may support one or more portions of electric powertrain assembly 200 (FIG. 4). Further, as explained herein, one or more portions of electric powertrain assembly 200 may be part of structural frame 110 of snowmobile 100. For example, one or more portions of electric powertrain assembly 200 may replace a component of one or more of front frame portion 112, middle frame portion 114, tunnel 116, and overstructure 118, and be interposed between the components of one or more front frame portion 112, middle frame portion 114, tunnel 116, and overstructure 118 and/or being integrally formed as part of one or more of front frame portion 112, middle frame portion 114, tunnel 116, and overstructure 118.

Structural frame 110 supports a seat support 133 which may support an operator seat 132, which may also be referred to as a straddle seat. Seat support 133 extends along longitudinal centerline L of structural frame 110 and with specific reference to FIG. 3, may have a width that is less than a width W1 of tunnel 116. Operator seat 132 includes a longitudinal front extent 134, a longitudinal rear extent 136, and a longitudinal mid-point 135. Operator seat 132 is positioned rearward of a steering assembly 170 of snowmobile 100 and vertically above tunnel 116. As illustrated, operator seat 132 is positioned vertically spaced from tunnel 116, such that there is spacing directly between tunnel 116 and operator seat 132 that may be used for storage, as will be described further herein. As illustrated, operator seat 132 is cantilevered, specifically such that operator seat 132 is fixed to structural frame 110 at longitudinal front extent 134. With reference to FIG. 3, operator seat 132 has a width W1 that is less than a width W2 of tunnel 116. However, in some embodiments, width W1 may be approximately equal to or greater than width W2. However, variations of operator seat 132 shape and positioning may be incorporated. For example, operator seat 132 may be positioned a vertical height higher than that shown in FIG. 1, and shape of operator seat 132 may be varied as well.

Referring to FIGS. 1-3, front suspension 120 includes a spindle 122A which is rotatably coupled to skis 106 at a lower end. The point of connection between spindle 122A and left ski 106A defines a spindle axis 121 which acts as an axis of rotation for left ski 106A to pivot about during movement of snowmobile 100. Spindle 122A is further rotatably coupled to a lower control arm 126A and an upper control arm 128A. Lower control arm 126A and upper control arm 128A are each rotatably coupled to front frame portion 112 of structural frame 110. A shock absorber 130A is rotatably coupled to one or more of lower control arm 126A and upper control arm 128A and to front frame portion 112 of structural frame 110. Shock absorbers 30, in embodiments, may be electronically controlled shock absorber having adjustable compression and/or rebound damping characteristics. Additionally details regarding exemplary electronically controlled shock absorbers are described in U.S. patent application Ser. No. 17/325,062, filed May 19 0221, titled SYSTEMS AND METHODS OF ADJUSTABLE SUSPENSIONS FOR OFF-ROAD RECREATIONAL VEHICLES, the entire disclosure of which is expressly incorporated by reference herein.

Referring to FIGS. 1-3, structural frame 110 is supported by endless track assembly 104 through a rear suspension 141. An opening 115 is provided for a drive shaft having a sprocket axis 119 (see FIG. 2). The drive shaft supports an endless track drive sprocket and defines sprocket axis 119. The drive shaft is configured to engage and move endless track belt 148 of endless track assembly 104 and is rotatably coupled to structural frame 110 and couples endless track assembly 104 to structural frame 110. In the illustrated embodiment, rear suspension 141 of endless track assembly 104 includes a plurality of slide rails 150, a plurality of control arms 152 rotatably coupled to tunnel 116 of structural frame 110, a plurality of idler wheels 154 coupled to the plurality of slide rails 150, and at least one shock absorber 156, illustratively front shock absorber 158 and rear shock absorber 160. One or both of illustrative front shock absorber 158 and rear shock absorber 160, in embodiments, may be an electronically controlled shock absorber having adjustable compression and/or rebound damping characteristics.

Rear suspension 141 further includes tensioning wheels 162 which are positioned at a rear portion of endless track assembly 104 and engage endless track belt 148 to control the tension on endless track belt 148. Referring to FIG. 1, in embodiments, tensioning wheels 162 is coupled to a tensioning rail 164. Tensioning wheels 162 and tensioning rail 164 is described further within U.S. Patent Application No. 63/295,560, filed Dec. 31, 2021, titled “ELECTRIC SNOWMOBILE,” which is expressly incorporated herein by reference in its entirety.

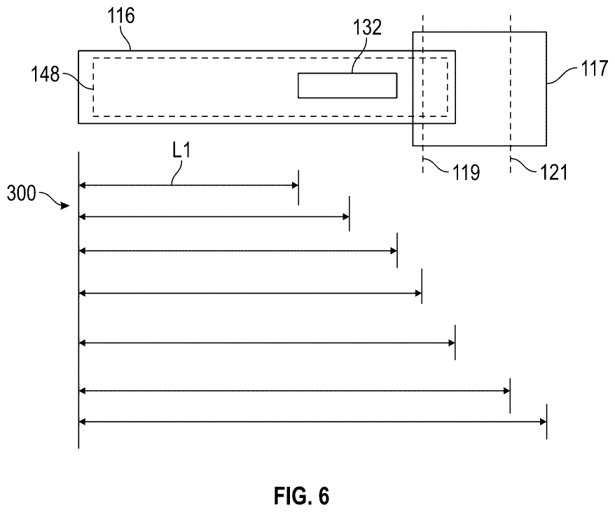

In embodiments, snowmobile 100 is powered for movement relative to the ground with an electric powertrain assembly 200. With reference to FIG. 4, electric powertrain assembly 200 includes at least one electric motor assembly 202 including an electric motor 204 (FIG. 6). Electric motor assembly 202 may include a motor housing in which are positioned a drive shaft supporting a rotor and a stator. In embodiments, at least one electric motor assembly 202 further includes an electronic controller that controls the operation of electric motor 204. Electric motor 204 receives electrical power through electrical connectors. In various embodiments, at least one electric motor assembly 202 receives electrical energy from at least one battery assembly 240. In embodiments, a plurality of battery assemblies 240 are provided. Battery assembly 240 includes a battery housing (not shown) in which are positioned a plurality of battery cells (not shown). Exemplary battery cells may be prismatic, cylindrical, or other suitable shape. Exemplary battery cells include lithium-ion cells, nickel-cadmium cells and other suitable cell chemistries. Battery assembly 240 may be operatively coupled to a charger 260 to charge the battery cells. An exemplary charge port may be positioned where a gas cap would be on a gas-powered snowmobile or other suitable locations. Further, battery assembly 240 may be operatively coupled to a DC-DC converter 262 which controls the voltage level provided to electric motor assembly 202. More specifically, DC-DC converter 262 may receive voltage of approximately 100 VDC and lower the voltage level to approximately 12 VDC for use by battery assembly 240. However, various other voltage levels may be received by DC-DC converter 262 and various other voltage levels may be delivered by DC-DC converter 262. In embodiments, electric motor 204 of electric motor assembly 202 is a DC motor. In embodiments, electric motor 204 of at least one electric motor assembly 202 is an AC motor and an inverter 264 (FIG. 5) is provided in addition to or in place of DC-DC convertor. In embodiments, either DC-DC converter 262 or a second DC-DC converter receives power from battery assembly 240 and is converted to either AC accessory power or DC accessory power. In embodiments, at least one plug is provided to connect accessories, such as ice augers, stereos, heaters, cooling devices, computer, and a heater for battery assembly 240, as will be describe further herein.

Electric powertrain assembly 200 further includes an electronic controller 270. Electronic controller 270 includes at least one processor 272 and at least one non-transitory computer readable medium, memory 274. In embodiments, electronic controller 270 is a single unit that controls the operation of various systems of electric powertrain assembly 200 and optionally snowmobile 100. In embodiments, electronic controller 270 is a distributed system comprised of multiple controllers each of which control one or more systems of electric powertrain assembly 200 and optionally snowmobile 100 and may communicate with each other over one or more wired and/or wireless networks. Electric powertrain assembly 200 further includes an operator interface 280 which includes a plurality of input devices 282 and a plurality of output devices 284. Exemplary input devices 282 include levers, buttons, switches, soft keys, touch screens, and other suitable input devices. Exemplary output devices 284 include lights, displays, audio devices, tactile devices, and other suitable output devices. In embodiments, operator interface 280 includes a display, such as a touch screen display, and electronic controller 270 interprets various types of touches to the touch screen display as inputs and controls the content displayed on touch screen display. In embodiments, input devices 282 includes a mode input. Mode input provides an indication to electronic controller 270 of limits, setups, and other characteristics for electric powertrain assembly 200 of snowmobile 100 and/or other components and systems of snowmobile 100.

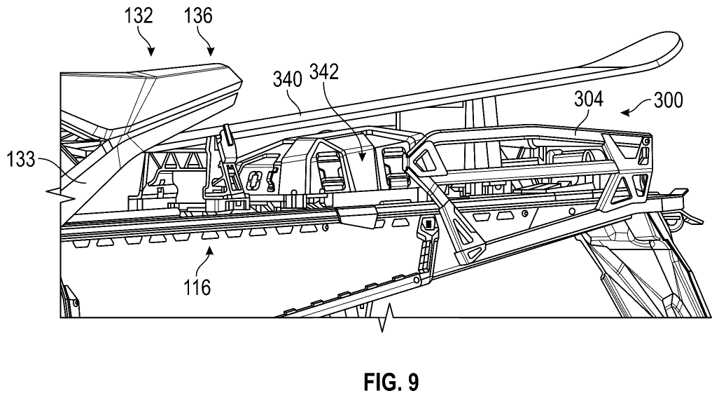

Electric powertrain assembly 200, including electric motor assembly 202, the at least one battery assembly 240, and electronic controller 270 are described further within U.S. Patent Application No. 63/295,560, filed Dec. 31, 2021, titled “ELECTRIC SNOWMOBILE,” which is expressly incorporated herein by reference in its entirety. The use of electric powertrain assembly 200 allows for flexibility in the positioning of the various components of the electric powertrain assembly 200 within the snowmobile 100. This may allow for increased flexibility and optimized space for storage within snowmobile 100. For example, areas where an engine or fuel tank may have been required to be positioned in previous gas powered snowmobiles, this space may now be used for storage based on the positioning of the batteries, motors, and other components of electric powertrain assembly 200. Various configurations of electric powertrain assembly 200 and exemplary storage areas will be described further herein with reference to FIGS. 5-9.

FIG. 5 illustrates a side view of snowmobile 100 and an embodiment for a storage support 300. Storage support 300 is configured for receiving accessories and/or tools that are to be towed and/or stored on snowmobile 100 during operation. FIG. 5 illustrates storage support 300 extending from the rear portion of snowmobile 100 through to the front portion of snowmobile 100. However, storage support 300 may extend at varying lengths relative for snowmobile 100.

For example, FIG. 6 illustrates a top representative view of components of snowmobile 100 and varying length options for storage support 300. Specifically, FIG. 6 illustrates tunnel 116 with operator seat 132 and endless track 104 shown in phantom. Extending longitudinally forward from tunnel 116 is a bulkhead 117 of snowmobile 100. As illustrated, various embodiments of a length L1 of storage support 300 are shown relative to snowmobile 100. Specifically, in some embodiments, length L1 of storage support 300 may extend from longitudinal rear end 111 of tunnel 116 to longitudinal rear extent 136 of operator seat 132. In other embodiments, length L1 of storage support 300 may extend from longitudinal rear end 111 of tunnel 116 to longitudinal mid-point 135 of operator seat 132. In other instances, length L1 of storage support 300 extends from longitudinal rear end 111 of tunnel 116 to a longitudinal front extent 134 of operator seat 132. In further embodiments, storage support 300 may extend from longitudinal rear end 111 of tunnel 116 to a longitudinal position of sprocket axis 119. In other instances, storage support 300 may extend to a longitudinal position of spindle axis 121. Further, it may be desired in some embodiments for storage support 300 to extend from longitudinal rear end 111 of tunnel 116 to a longitudinal front end of bulkhead 117, or longitudinal front end of snowmobile 100. However, various other lengths of storage support 300 may be incorporated. Also, although storage support is shown extending to a rear end of tunnel 116, it may start at a location rearward of operator seat 132 and short of the rear end of tunnel 116.

With reference again to FIG. 5, storage support 300 may be positioned above tunnel 116. Storage support 300 may be an exposed storage support, such that it is enclosed on only three or less sides, for example, a bottom side defined by a top of tunnel 116, a right side, and a left side. In the illustrative embodiment of FIG. 5, storage support 300 is only enclosed on the lower surface by tunnel 116 and as such, storage may be accessed from a top side, right side, left side, rear side or front side of storage support 300. In other words, storage support 300 is exposed to the external environment on these sides. In some embodiments, an entirety of storage support 300 extending rearward of operator seat 132 is exposed to the external environment. In these embodiments, storage support 300 may be accessible from a position rearward of operator seat 132. Various other configurations of storage support 300 may be incorporated, as will be described further herein.

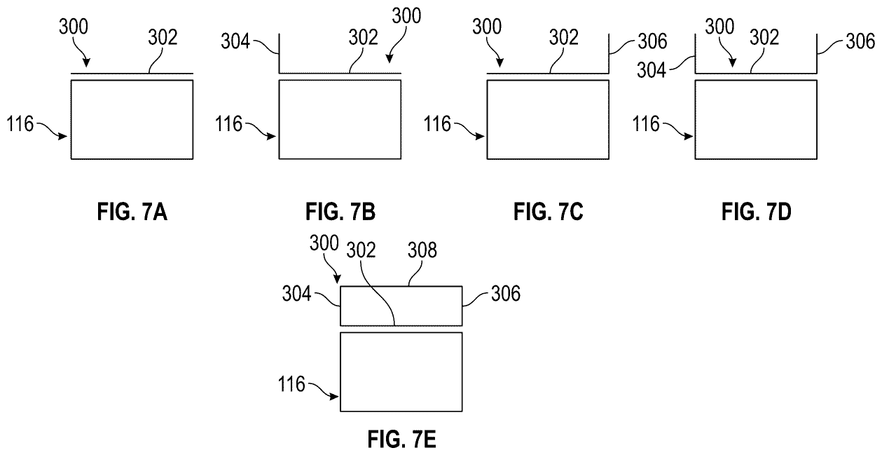

Specifically, FIGS. 7A-7E illustrate varying configurations of storage support 300. As illustrated in FIG. 7A, storage support 300 may be supported by tunnel 116 and have a bottom surface 302. In this embodiment, storage support 300 is exposed on each lateral side and a top side. In various embodiments, bottom surface 302 may be a top surface of tunnel 116, or may be an a separate support structure placed onto tunnel 116 or vertically spaced from tunnel 116. The illustrative embodiment of FIG. 7B illustrates storage support 300 having bottom surface 302 and a left side wall 304 extending upward from bottom surface 302. In this way, left side wall 304 may provide additional structure and support for any accessories supported within storage support 300. Further, as illustrated in FIG. 7C, storage support 300 may include bottom surface 302 and right side wall 206, such that there is additional structure and support for accessories supported within support storage 300. In various embodiments, for example in the illustrative embodiment of FIG. 7D, storage support 300 may include bottom surface 302, right side wall 306 and left side wall 304, such that items positioned within storage support 300 are secured on both lateral sides of storage support 300. In further embodiments, for example the illustrative embodiment of FIG. 7E, storage support 300 includes bottom surface 302, right side wall 306, left side wall 304, and a top wall 308. In this way, storage support 300 may be enclosed on four sides for protecting items within storage support 300, as will be described further herein. Further, in some embodiments, only a portion of storage support 300 includes any one of the above embodiments described in FIGS. 7A-7E. For example, in some instances, a longitudinal portion of storage support 300 may include bottom surface 302, right side wall 306 and left side wall 304, while another longitudinal portion of storage support 300 may only include bottom surface 302.

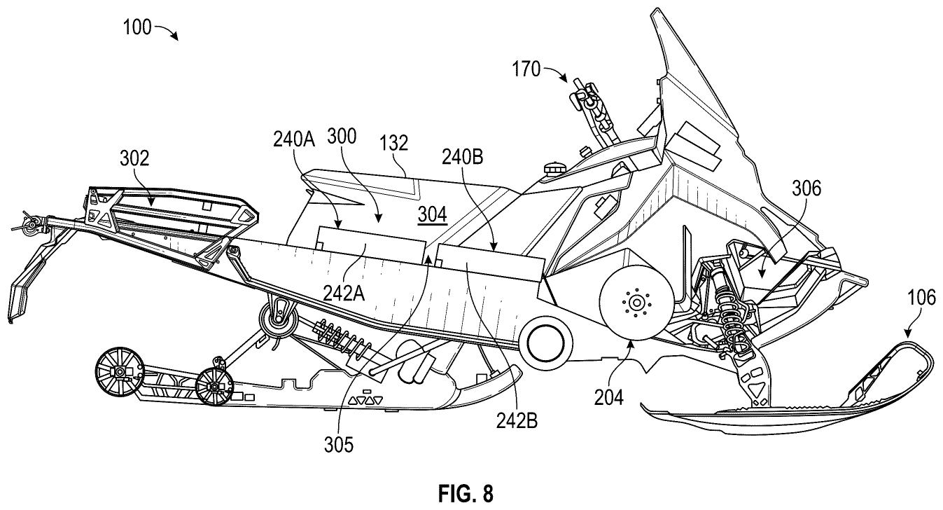

FIG. 8 illustrates an additional configuration of snowmobile 100 and storage support 300. As illustrated, storage support 300 extends underneath operator seat 132. In this embodiment, storage support 300 may be enclosed from the external environment. In other words, a portion of storage support 300 that extends underneath operator seat 132 may be enclosed on at least four sides, as previously described with reference to FIG. 7E while another portion of storage support 300 is exposed. As illustrated, the portion of storage support 300 extending underneath operator seat 132 may be referred to as central portion 305 of storage support 300. While central portion 305 may be enclosed, in some embodiments, operator seat 132 may be removable such that it can be lifted and accessories within central portion 305 may be accessed. However, in some instances, accessories within central portion 305 may be accessible along longitudinal centerline L of tunnel 116. In other words, storage support 300 may include doors and/or openings anywhere at any point along longitudinal centerline L for accessing accessories within central portion 305.

With reference still to FIG. 5 and as previously described with reference to FIG. 6, storage support 300 may additionally include an enclosed portion extending into bulkhead 117 of snowmobile 100. The enclosed portion may be enclosed on a bottom side, right side, left side, and a top side. Additionally, in the illustrative embodiment of FIG. 5, storage support 300 includes a stop surface 309 defining a longitudinally forward extent of storage support 300. In some embodiments, entirety of storage support 300 may be continuous. In these embodiments, storage support 300 may be considered a pass through storage from the rear portion to the front portion of snowmobile 100. This may provide the benefit of storing items and accessories that have a length that is approximately equal to or greater than a length of snowmobile 100, which still ensuring secured storage of these accessories. In other embodiments, storage support 300 may include several components that are distinct from one another. This may allow for compartmentalizing storage support 300 such that items may be stored and remain separated from one another, if desired.

While FIG. 5 illustrates storage support 300 extending through the entire snowmobile 100, any length of storage support 300 may be incorporated, as described with reference to FIG. 6. Additional configurations of snowmobile 100, namely the components of electric powertrain assembly 200 and the individual portions of storage support 300, will be described further herein.

FIG. 8 illustrates a side view of snowmobile 100. Specifically, as illustrated, electric powertrain assembly 200 includes a first battery 242a and a second battery 242b positioned within a first battery assembly 240a and a second battery assembly 240b, respectively. First and second batteries 242a, 242b are positioned supported by tunnel 116 and within storage support 300. Additionally, electric motor 204 is positioned forward of tunnel 116 and each of first and second batteries 242a, 242b. In this configuration, a portion of storage support 300 extending rearwardly of first battery assembly 242a is available for storage, and is exposed to the external environment on at least two sides. More specifically, the exposed portion of storage support 300 includes at least right side wall 306 extending upward for providing additional securement for accessories within storage support 300, while remaining exposed to the external environment on at least a rear portion of storage support 300 and a top side of storage support 300.

FIG. 8 illustrates an enlarged view of the portion of storage support 300 longitudinally rearward of seat support 300 with various tools and/or accessories incorporated. Specifically, storage support 300 is illustrated extending rearward of operator seat 132 and accommodates accessories such as skis 340 and a storage unit 342. However, various other accessories may be incorporated including, for example, a snowboard, a supplement battery, a battery pack, a shovel, and/or any other tool or accessory that may be desired to store on snowmobile 100. The accessories may be coupled to tunnel 116 through various coupling mechanisms. More specifically, storage support 300 may include one or more interfaces for receiving one or more retainers. The interfaces may include semi-circular cut outs, holes with an enlarged recess, or various other features for coupling features. The coupling features may be expandable retainers that are coupled with the interfaces and which may releasably couple with an accessory. In embodiments, the retainer may be the Lock & Ride system available from Polaris, Inc., located at 2100 Hwy. 55, Medina, MN 55340 such as that shown in U.S. Patent Application Publication No. 63/056,201, filed July 2020, and entitled “ARTICLE MOUNTING SYSTEM FOR A VEHICLE,” the complete disclosure of which is expressly incorporated herein by reference. Any number of interfaces and retainers may be incorporated to secure accessories to tunnel 116. Additionally, in some embodiments, there may be a detachable cover coupled to at least a portion of storage support 300 to protect the accessories while stored on snowmobile 100. In embodiments, this cover may be secured to the snowmobile 100 with an interface and a retainer, for example a recess and the Lock & Ride system as previously disclosed, however various other coupling mechanisms may be incorporated.

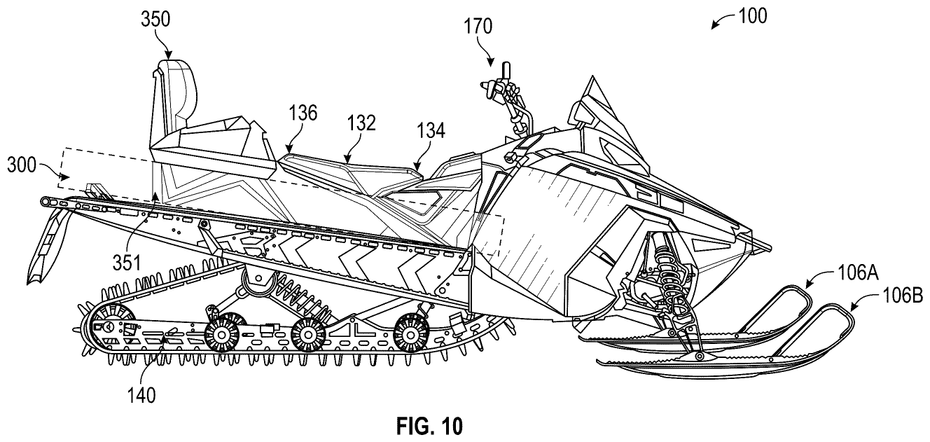

With reference to FIG. 10, an additional configuration of storage support 300 is illustrated. Specifically, a supplemental seat 350 is incorporated onto snowmobile 100 rearward of operator seat 132 which may allow for an additional passenger to use snowmobile 100. Specifically, a retainer such as the Lock & Ride system, or other applicable coupling mechanism, may be used to secure supplemental seat 350 onto tunnel 116 through a bracket 251. The retainer may be expandable such that after coupling with supplemental seat 350, a spacing remains available beneath supplemental seat 350 and above tunnel 116 which may be used for storage. In these embodiments, at least a portion of storage support 300 longitudinally rearward of operator seat 132 may become at least partially enclosed, such that supplemental seat 350 acts as a cover over the accessories positioned under supplemental seat 350. The use of coupling supplemental seat 350 with tunnel 116 through bracket 351 and a coupling mechanism such as the Lock & Ride system, or other applicable coupling systems, may be beneficial for allowing easier removal and decoupling of supplemental seat 350 with snowmobile 100 when desired.

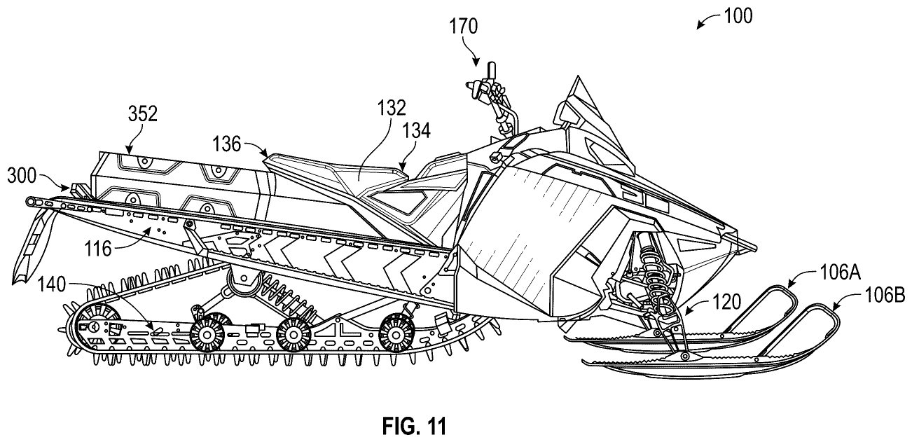

FIG. 11 illustrates an additional configuration of storage support 300. In this illustrative embodiment, storage support 300 may accommodate a supplement battery pack 352 rearward of operator seat 132. Supplement battery pack 352 may be coupled to tunnel 116 using interfaces and retainers, for example an interface for receiving the Lock & Ride system, or any other suitable coupling feature. This provides the advantage of being able to bring an extra battery with snowmobile 100 during use. Supplement battery pack 352 may be used for charging other electric accessories accommodated onto snowmobile 100, or may be used for connecting with electric powertrain of snowmobile 100 to extend the charge of the snowmobile 100 during operation. As illustrated, supplement battery pack 352 is positioned within storage support 300 towards rear longitudinal end 111 of tunnel, as well as extending under operator seat 132. This may provide the advantage of protecting a portion of supplement battery pack 352, for example a plug-in portion of supplement battery pack 352, that may need to be preserved from the external environment within the portion of storage support 300 extending beneath operator seat 132.

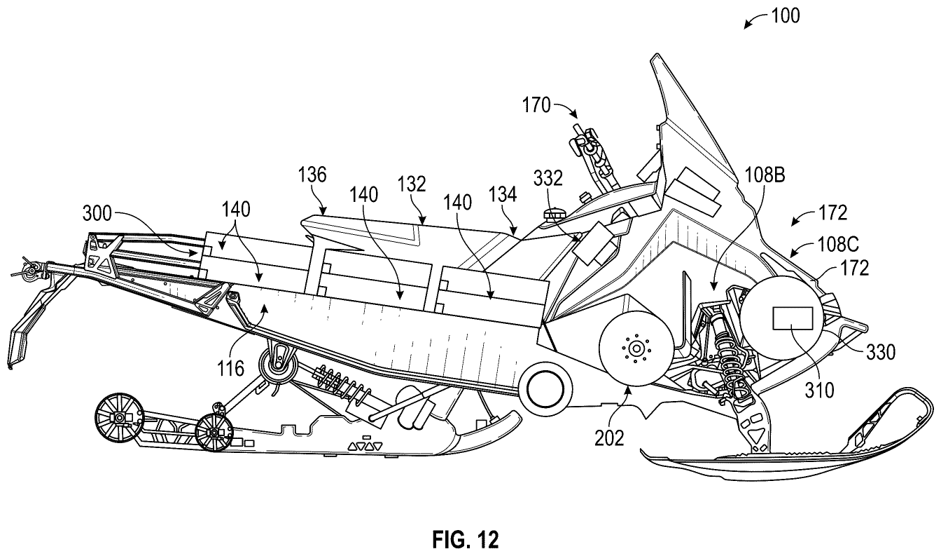

With reference now to FIG. 12, a portion of storage support 300 is illustrated accommodating battery assemblies 240 of electric powertrain assembly 200. As illustrated, two battery assemblies 140 are positioned within storage support 300 rearward of operator seat 132 and exposed to external environment. Further, four battery assemblies 140 are positioned within storage support 300 extending under operator seat 132. As previously disclosed, the portion of storage support 300 extending underneath operator seat 132 may be enclosed on at least four sides, and as such, battery assemblies 140 positioned beneath operator seat 132 may be protected from the external environment. The positioning of the battery assemblies 140 in this configuration frees up space forward of tunnel 116 and forward of steering assembly 170 for a front storage to be incorporated. For example, snowmobile 100 may include an enclosed storage compartment 330 positioned within bulkhead 117 of snowmobile 100 and separate from storage support 300.

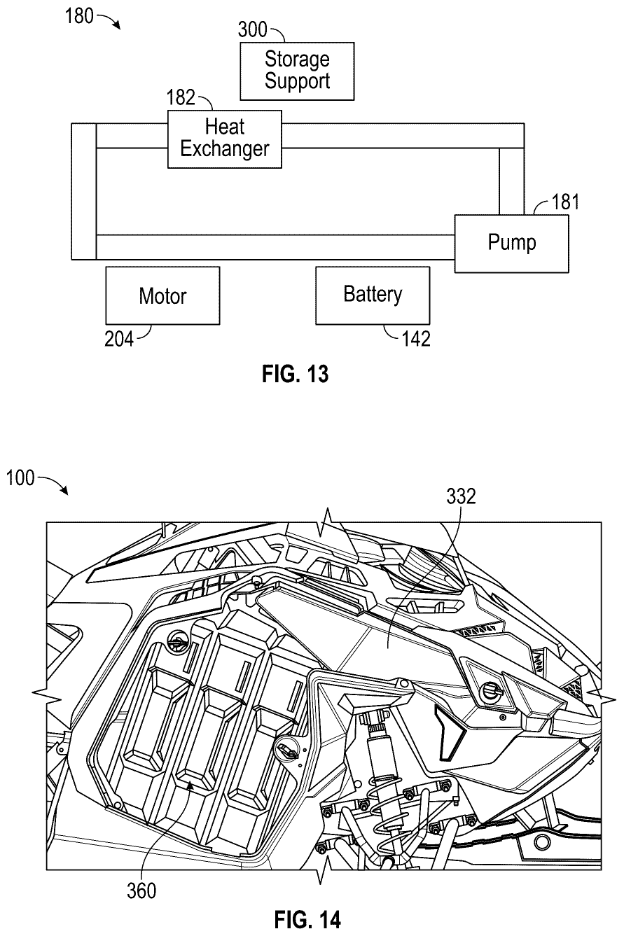

Enclosed storage compartment 330 may be entirely enclosed, or bordered by a panel and/or structure on each side, within snowmobile 100 which may be beneficial for at least the ability to accommodate valuable items that require protection from the external environment. For example, this may be an ideal storage place for electronics, food, or other soft goods. In these embodiments, it may also be advantageous for enclosed storage compartment 330 to be temperature regulated through a heating system between various components of electric powertrain assembly 200 and enclosed storage compartment 330. More specifically, as illustrated in the schematic of FIG. 13, snowmobile 100 may include a heating system 180 including a heat exchanger 182 to transfer heat generated from the batteries and/or other components of electric powertrain assembly 200, through to enclosed storage compartment 330 to deliver heat. Specifically, heat exchanger 182 may include ducts or other conduits to carry heat from motor 202 and/or battery 142 through to enclosed storage compartment 330 of storage support 300, such that that the heat may increase the temperature around and/or within enclosed storage compartment 330. This may be especially advantageous when food is being stored within snowmobile 100 and needs to remain warm during operation of snowmobile 100. Additionally, this may be beneficial for storing electronics or other valuables that are desired to maintain a higher temperature and avoid damage from cold temperatures that may be incorporated. While snowmobile 100 is described as having components heating enclosed storage compartment 330, in some embodiments snowmobile 100 may be configured for cooling enclosed storage compartment 330.

With reference again to FIG. 12, enclosed storage compartment 330 may be accessed through any one or more of the plurality of body panels 108. For example, front body panel 108c may be a hood 172. In the illustrative embodiment of FIG. 12, hood 172 of snowmobile 100 is illustrated in a closed position over enclosed storage compartment 330. In this position, enclosed storage compartment 330 may be in an inaccessible configuration. In phantom, hood 172 is illustrated in an open position, wherein hood 172 may have a hinged connection to snowmobile 100 such that an operator may hinge open hood 172 to provide access to enclosed storage compartment 330. In other embodiments, hood 172 may have a hinged connection at the front portion of snowmobile 100, such that hood 172 opens rearwardly for accessing contents of enclosed storage compartment 330. Further, hood 172 may be configured to hinge open to a right side and/or a left side of snowmobile 100. In further embodiments, hood 172 may be removably coupled to snowmobile 100 such that hood 172 may be completely removed from snowmobile 100 to provide access to enclosed storage compartment 330. However, as previously noted, there may be additional access points to enclosed storage compartment 330 on a side of snowmobile 100. For example, a door 310 is illustrated on right body panel 108b of snowmobile 100 which may be opened by an operator to access enclosed storage compartment 330. While illustrated on right body panel 103b, door 310 may alternatively or additionally positioned on left body panel 108a, top body panel 108d, or rear body panel 108e. Further, snowmobile 100 may include an additional storage compartment 332 positioned adjacent steering assembly 170 and directly forward of operator seat 132. This may be beneficial for storing items that the operator may want quick access to during or after operation of snowmobile 100, for example keys or a phone. Various other positions or configuration of storage compartment 332 may be incorporated into snowmobile 100. Storage compartment 332 may be accessed through a hinged door or cap that secures against snowmobile 100 to enclose storage compartment 332 while allowing for easy access when desired.

Additionally, with reference still to FIG. 12, enclosed storage component 330 may include a drainage system 362 for ensuring that fluids are discarded from enclosed storage compartment 330 to avoid damage to enclosed storage compartment 330 and/or any accessories stored within enclosed storage compartment 330. More specifically, drainage system 362 may include at least one drain extending from a bottom surface of enclosed storage compartment 330 and may include piping to dispose of the fluid out of enclosed storage compartment 330 and ultimately out of snowmobile 100. The drainage system 362 may be advantageous for at least the ability to dispose of any snow that may be present within enclosed storage compartment 330. Allowing for the removal of snow and/or other fluid through the drainage system 362 aids in maintaining the proper function of the accessories stored within enclosed storage compartment 330, and reducing any damage to those accessories.

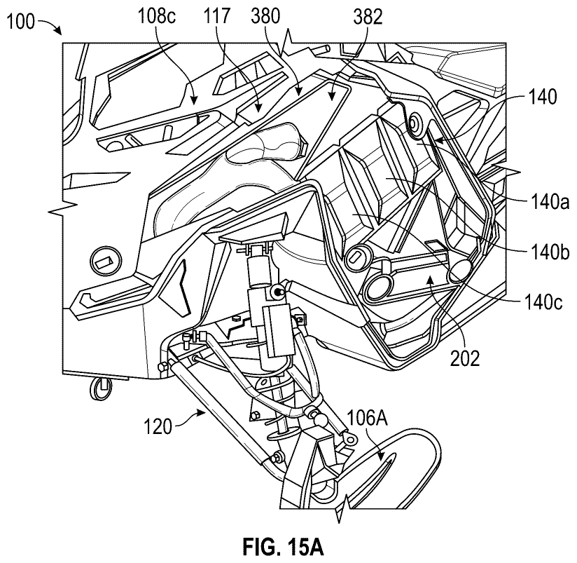

FIG. 14 illustrates an additional configuration of the front portion of snowmobile 100. As illustrated, snowmobile 100 includes an electrified propulsion system 360 positioned within bulkhead 117 and rearward of front suspension 120 (FIG. 1). Above electrified propulsion system 360, storage snowmobile 100 includes smaller storage portion 312 which may be beneficial for accommodating smaller items and accessories. In various other embodiments, snowmobile 100 may include a cover where electrified propulsion system 360 is currently shown, and further storage may be positioned behind the cover.

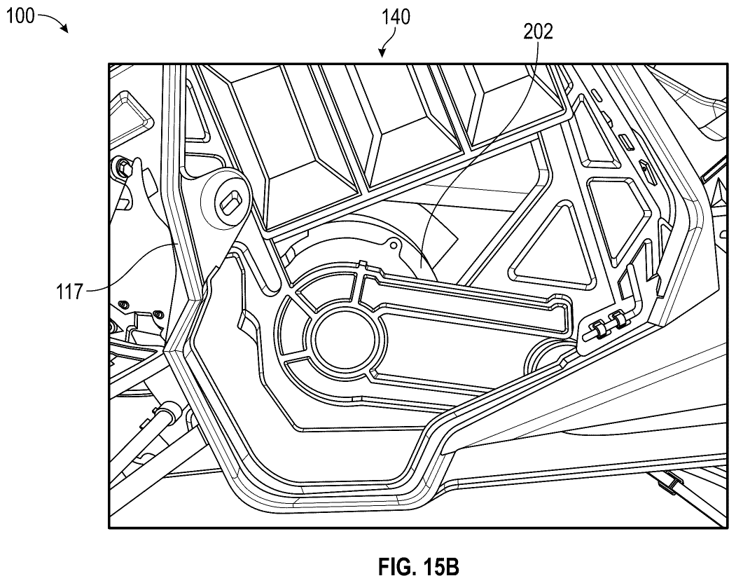

FIG. 15A illustrates a left side view of a portion of snowmobile 100, illustratively, left side of bulkhead 117, a portion of front suspension 120, and a portion of front left ski 106A. As illustrated, motor 202 is positioned within a lower portion of bulkhead 117. FIG. 15B illustrates an enlarged view of motor 202 positioned within bulkhead 117. As illustrated in FIGS. 15A and 15B, snowmobile 100 includes battery assemblies 140 positioned above motor 202. In the illustrative embodiment of FIGS. 15A-15B, snowmobile 100 includes a first battery assembly 140a, a second battery assembly 140b and a third battery assembly 140c. However, in other embodiments, other amounts of battery assemblies 140 may be incorporated. With reference still to FIG. 15A, above battery assemblies 140, bulkhead 117 further includes a pass through storage support 380. FIG. 15C illustrates an enlarged view of pass through storage support 380. As illustrated, pass through storage support 380 is positioned above battery assemblies 140 and below a top body panel of snowmobile 100, for example top body panel 108c. Pass through storage support 380 extends from a first lateral side through to a second lateral side of snowmobile 100. Further, as illustrated, pass through storage support 380 includes a generally polygonal shape having a plurality of sides that collectively form an interior region 382 for receiving various accessories and/or tools to be stored. In other embodiments, pass through storage support 380 may include various other configurations and shapes.

Interior region 382 of pass through storage support 380 may be accessed from either lateral side of pass through storage support 380. While illustrated as being open on either side in FIG. 15C, in some embodiments, the pass through storage support 380 may include side panels that allow for interior region 382 to be completely enclosed. For example, pass through storage support 380 may include a hinged or otherwise couplable side panel that connects the linear sides of pass through storage support 380, and as such, encloses interior region 382. The one or more side panels side panels or other retainers, such as nets, may be removed from pass through storage support 380 when it is desired to remove accessories and/or tools from pass through storage support 380, and may be reattached when desired to maintain the secure positioning of accessories and/or tools positioned within pass through storage support 380. In embodiments, an inner surface of the body panels 108 which are removable to provide access to storage support 380 mate with the plurality of laterally sides of storage support 380 to capture articles within interior 382 of storage support 380.

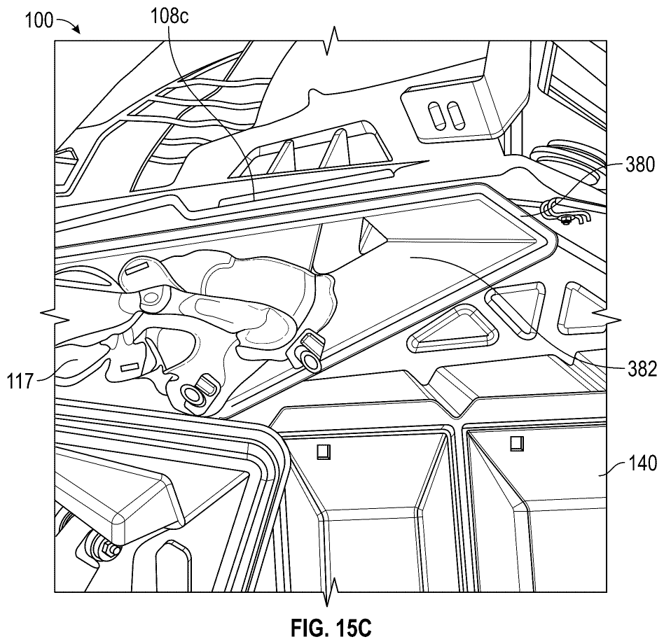

With reference now to FIG. 16 an additional storage component is illustrated in combination with pass through storage component 280 and battery assemblies 140. In the illustrative embodiment of FIG. 16, an additional storage support 400 is arranged directly laterally adjacent motor 202. Storage support 400 is positioned vertically below battery assemblies 140 and may extend laterally outward from motor 202. In some embodiments, storage support 400 may include a cover positioned over storage support 400 to enclose the accessories and/or tools supported by storage support 400.

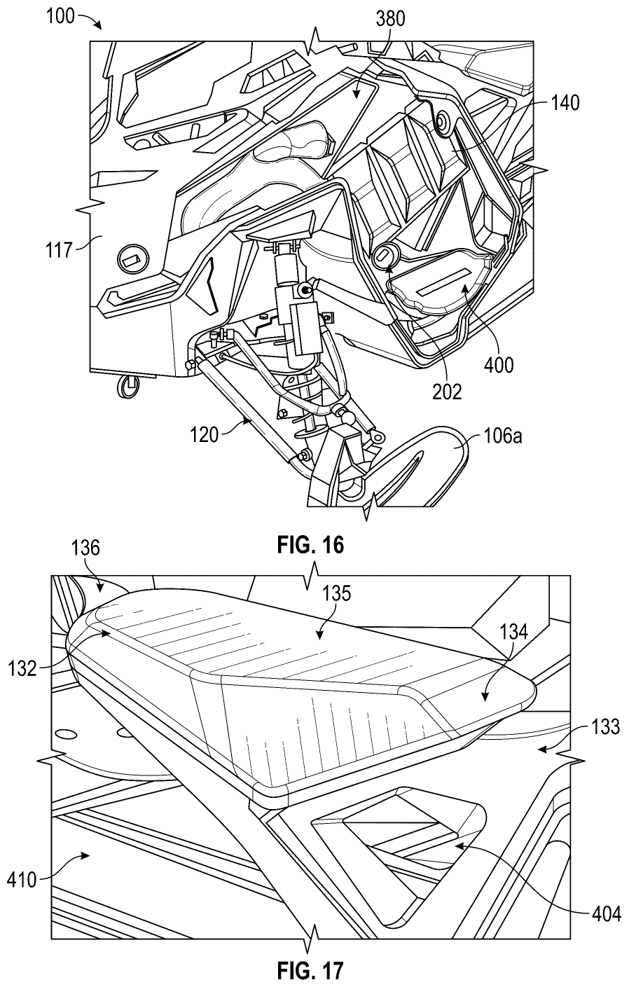

While bulkhead 117 may accommodate further storage as described with reference to FIGS. 15A-16, additional storage may also be accommodated beneath operator seat 132 and seat support 133. FIG. 17 illustrates an enlarged right side view of operator seat 132. As previously described and as illustrated, operator seat 132 is cantilevered such that there may be open space beneath operator seat 132 and/or seat support 133 which may be used to accommodate storage. Snowmobile 100 may include additional storage as part of the seat support 133. Referring to FIG. 17, a compartment 404 includes an opening within seat support 133 that may accommodate various accessories and/or tools. The positioning of compartment 404 and the size may make it optimal for storing smaller valuables that the operator may want quick access to. While illustrated as an opening within seat support 133 and exposed to the exterior from a side of seat support 133, compartment 404 may include one or more side panels or other retainers, such as nets, to reversible enclose compartment 404.

Further, the configuration of operator seat 132 and seat support 133 results in a storage support 410 beneath operator seat 132 extending at least between rear longitudinal point 136 and mid longitudinal point 135 of operator seat 132 as available for storage. Storage support 410 may extend vertically between tunnel 116 and an underside of operator seat 132 and may be used for items that may be positioned onto tunnel 116 during operation. Similar to the previously described storage supports, in some embodiments, side panels may be used to enclose storage support 410 extending above tunnel 116 and beneath operator seat 132 (or seat support 133) to allow for additional securement of the accessories positioned within storage support 410.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A snowmobile extending along a longitudinal axis, the snowmobile comprising:
a plurality of ground engaging members including an endless track, a left front ski, and a right front ski, the endless track being positioned rearward of the left front ski and the right front ski;
an electric powertrain operatively coupled to the endless track to power movement of the endless track;
a structural frame supported by the plurality of ground engaging members, the structural frame including a rear portion including a tunnel and a front portion positioned forward of the tunnel;
a steering assembly supported by the structural frame and operatively coupled to the left front ski and the right front ski to steer the snowmobile;
a seat support supported by the plurality of ground engaging members;
a straddle seat supported by the seat support and positioned along the longitudinal axis of the snowmobile over the endless track, the straddle seat extending longitudinally rearward of the steering post of the steering assembly, the straddle seat has a longitudinal front extent, a longitudinal rear extent, and a longitudinal mid-point; and
a storage support above the endless track and extending under the straddle seat of the snowmobile, the storage support being accessible along a longitudinal direction of the snowmobile while the straddle seat is supported by the seat support, the storage support extends longitudinally along the tunnel from a location rearward of the longitudinal rear extent of the straddle seat to at least forward of the longitudinal mid-point of the straddle seat.

2. The snowmobile of claim 1, wherein the storage support extends longitudinally under an entire length of the straddle seat.

3. The snowmobile of claim 1, wherein the storage support extends longitudinally from the location rearward of the longitudinal rear extent of the straddle seat to at least a rotational axis of a drive sprocket engaged with the endless track.

4. The snowmobile of claim 1, wherein the storage support extends longitudinally from the location rearward of the longitudinal rear extent of the straddle seat to at least a front lateral extent of the tunnel.

5. The snowmobile of claim 1, wherein the storage support extends longitudinally from the location rearward of the longitudinal rear extent of the straddle seat to at least a spindle axis of the left front ski.

6. The snowmobile of claim 1, wherein the storage support extends longitudinally from the location rearward of the longitudinal rear extent of the straddle seat to a front longitudinal extent of the snowmobile.

7. The snowmobile of claim 1, wherein the storage support has a bottom support structure and at least a portion of storage support has at least a first lateral sidewall to enclose the storage support on at least one lateral side.

8. The snowmobile of claim 1, wherein the storage support has a bottom support structure and at least a portion of storage support has at least a first lateral sidewall and a second lateral sidewall to enclose the storage support on both lateral sides.

9. The snowmobile of claim 1, wherein the storage support has a bottom support structure and at least a portion of storage support has at least a first lateral sidewall and a second lateral sidewall to enclose the storage support on both lateral sides and a top wall to enclose the storage support from above.

10. The snowmobile of claim 7, wherein the portion of the storage support has a front stop wall.

11. The snowmobile of claim 1, wherein the storage support includes a first portion which is enclosed on both lateral sides, a front, and a top and a second portion which is accessible along the longitudinal direction of the snowmobile and at least one lateral side of the snowmobile.

12. The snowmobile of claim 11, wherein the second portion of the storage support is exposed to the environment on at least a first side, second side, and a top side.

13. The snowmobile of claim 1, further comprising an enclosed storage compartment separate from the storage support.

14. The snowmobile of claim 13, further comprising a plurality of body panels positioned forward of the straddle seat, wherein the enclosed storage compartment is accessible through at least one of the plurality of body panels.

15. The snowmobile of claim 14, wherein the plurality of body panels includes a hinged hood which provides access to the enclosed storage compartment.

16. The snowmobile of claim 13, further comprising a heating system which is positioned to heat the enclosed storage compartment of the snowmobile.

17. The snowmobile of claim 16, wherein the electric powertrain includes an electric motor operatively coupled to the endless track and at least one battery operatively coupled to the electric motor, the heating system removing heat from at least one of the electric motor and the at least one battery to regulate a temperature of the enclosed storage compartment.

18. The snowmobile of claim 1, wherein the storage support includes a plurality of interfaces adapted to couple cargo to the storage support.

19. The snowmobile of claim 18, wherein the plurality of interfaces cooperate with expandable retainers to couple cargo to the storage support.

20. The snowmobile of claim 1, wherein at least one battery is positioned between the storage support and the tunnel.

21. The snowmobile of claim 1, wherein a passenger seat is operatively coupled to the tunnel and the storage support extends underneath the passenger seat.

22. The snowmobile of claim 1, wherein a supplemental battery is operatively coupled to the tunnel and extends at least partially beneath the straddle seat.

23. A snowmobile extending along a longitudinal axis, the snowmobile comprising:
a plurality of ground engaging members including an endless track, a left front ski, and a right front ski, the endless track being positioned rearward of the left front ski and the right front ski;
an electric powertrain operatively coupled to the endless track to power movement of the endless track;
a structural frame supported by the plurality of ground engaging members, the structural frame including a rear portion including a tunnel and a front portion positioned forward of the tunnel;
a steering assembly supported by the structural frame and operatively coupled to the left front ski and the right front ski to steer the snowmobile;
a seat support supported by the plurality of ground engaging members;
a straddle seat supported by the seat support and positioned along the longitudinal axis of the snowmobile over the endless track, the straddle seat extending longitudinally rearward of the steering post of the steering assembly;
a plurality of body panels positioned forward of the endless track, the plurality of body panels including a removable left side lateral body panel and a removable right side lateral body panel; and
a storage support positioned forward of the endless track, the storage support having an interior accessible through both the removable left side lateral body panel and the removable right side lateral body panel.

24. The snowmobile of claim 23, wherein the storage support is positioned over the left front ski and the right front ski.

25. A snowmobile extending along a longitudinal axis, the snowmobile comprising:
a plurality of ground engaging members including an endless track, a left front ski, and a right front ski, the endless track being positioned rearward of the left front ski and the right front ski;
an electric powertrain operatively coupled to the endless track to power movement of the endless track;
a structural frame supported by the plurality of ground engaging members, the structural frame including a rear portion including a tunnel and a front portion positioned forward of the tunnel;
a steering assembly supported by the structural frame and operatively coupled to the left front ski and the right front ski to steer the snowmobile;
a seat support supported by the plurality of ground engaging members; and
a cantilevered straddle seat supported by the seat support and positioned along the longitudinal axis of the snowmobile over the endless track, the cantilevered straddle seat extending longitudinally rearward of the steering post of the steering assembly.
